(19) United States
(12) Patent Application Publication
(10) Pub. No.: US 2025/0022186 A1
(43) Pub. Date: Jan. 16, 2025

(54) TYPOGRAPHICALLY AWARE IMAGE GENERATION

(71) Applicant: ADOBE INC., SAN JOSE, CA (US)

(72) Inventors: Nipun Jindal, Delhi (IN); Oliver Brdiczka, San Jose, CA (US)

(21) Appl. No.: 18/351,521

(22) Filed: Jul. 13, 2023

(51) Int. Cl. G06T 11/00; G06F 40/126; G06T 5/00; G06V 30/10

(52) U.S. Cl. CPC G06T 11/00; G06F 40/126; G06T 5/70; G06V 30/10; G06V 2201/07

(57) ABSTRACT

Systems and methods for typographically aware image generation are provided. An aspect of the systems and methods includes obtaining a prompt that includes a description of a typographic characteristic of text; encoding the prompt to obtain a prompt encoding; and generating an image that includes the text with the typographic characteristic based on the prompt encoding, wherein the image is generated using an image generation network that is trained to generate images having specific typographic characteristics.

### BACKGROUND

The following relates generally to machine learning, and more specifically to machine learning for image generation. Machine learning is an information processing field in which algorithms or models such as artificial neural networks are trained to make predictive outputs in response to input data without being specifically programmed to do so. For example, a machine learning model can be used to generate an image based on input data, where the image is a prediction of what the machine learning model thinks the input data describes.

Machine learning techniques can be used to generate images according to multiple modalities. For example, a machine learning model can be trained to generate an image based on a text input or an image input, such that the content of the image is determined based on information included in the text input or the image input.

### SUMMARY

Aspects of the present disclosure provide systems and methods for typographically aware image generation. According to an aspect of the present disclosure, an image generation system generates an image having a typographic characteristic specified by a prompt using an image generation network, where the image generation network is trained to be typographically aware (e.g., to generate an image having a specific typographic characteristic).

Because the image is generated using the typographically aware image generation network, the image includes a more accurate depiction of a text element than conventional image generation models can provide.

A method, apparatus, non-transitory computer readable medium, and system for typographically aware image generation are described. One or more aspects of the method, apparatus, non-transitory computer readable medium, and system include obtaining a prompt that includes a description of a typographic characteristic of text; encoding the prompt to obtain a prompt encoding; and generating an image that includes the text with the typographic characteristic based on the prompt encoding, wherein the image is generated using an image generation network that is trained to generate images having specific typographic characteristics.

A method, apparatus, non-transitory computer readable medium, and system for typographically aware image generation are described. One or more aspects of the method, apparatus, non-transitory computer readable medium, and system include obtaining training data comprising a training image and a training description comprising a description of a typographic characteristic of the training image; performing text recognition on a predicted image to obtain text recognition data, wherein the predicted image is generated based on the training description; and training an image generation network to generate images having the typographic characteristic based on the text recognition data and the training description.

An apparatus and system for typographically aware image generation are described. One or more aspects of the apparatus and system include one or more processors; one or more memory components coupled with the one or more processors; and an image generation network comprising parameters stored in the one or more memory components and trained to generate images having specific typographic characteristics, wherein the image generation network is trained using a training image and a training description of a text element of the training image.

### BRIEF DESCRIPTION OF THE DRAWINGS

FIG. 1 shows an example of an image generation system according to aspects of the present disclosure.

FIG. 2 shows an example of a method for generating a typographically aware image according to aspects of the present disclosure.

FIG. 3 shows an example of comparative generated images.

FIG. 4 shows an example of an image generated by the image generation system according to aspects of the present disclosure.

FIG. 5 shows an example of an image generation apparatus according to aspects of the present disclosure.

FIG. 6 shows an example of a guided latent diffusion architecture according to aspects of the present disclosure.

FIG. 7 shows an example of a U-Net according to aspects of the present disclosure.

FIG. 8 shows an example of a method for generating an image including text according to aspects of the present disclosure.

FIG. 9 shows an example of diffusion processes according to aspects of the present disclosure.

FIG. 10 shows an example of a method for training an image generation network according to aspects of the present disclosure.

FIG. 11 shows an example of a process for obtaining a decoded word for a training description according to aspects of the present disclosure.

FIG. 12 shows an example of a process for obtaining a text recognition token encoding according to aspects of the present disclosure.

FIG. 13 shows an example of a process for obtaining a training description according to aspects of the present disclosure.

FIG. 14 shows an example of a method for training an image generation network according to aspects of the present disclosure.

FIG. 15 shows an example of a computing device according to aspects of the present disclosure.

### DETAILED DESCRIPTION

Embodiments of the present disclosure relate generally to machine learning, and more specifically to machine learning for image generation. Machine learning techniques can be used to generate images according to multiple modalities. For example, a machine learning model can be trained to generate an image based on a text prompt or an image prompt, such that the content of the image is determined based on information included in the text prompt or the image prompt.

Prompt-based image generation via a machine learning model is more efficient and less laborious and time-consuming than manual creation of an image by a user. However, conventional image generation models (such as diffusion models and generative adversarial networks) are not able to generate an image that accurately depicts a description of a typographic characteristic included in a prompt because they have not been trained to do so. The lack of appropriate training to provide a typographically aware image generation model is due to a lack of suitable training data for the conventional image generation models to learn from.

Aspects of the present disclosure provide systems and methods for typographically aware image generation. According to an aspect of the present disclosure, an image generation system generates an image having a typographic characteristic specified by a prompt using an image generation network, where the image generation network is trained to be typographically aware (e.g., to generate an image having a specific typographic characteristic).

Because the image is generated using the typographically aware image generation network, the image includes a more accurate depiction of a text element than conventional image generation models can provide. Furthermore, the image generation network provides the image in a more efficient and less laborious and time-consuming manner than manually creating a comparable image by a user.

According to some aspects of the present disclosure, an image generation system obtains training data including a training image and a training description of the training image, where the training description includes a description of a typographic characteristic of the training image, and trains an image generation network to generate images having the typographic characteristic using the training data (for example, based on a loss function determined based on the training data).

According to some aspects, the image generation system generates the training description using a machine learning model, and the training description may therefore include a more precise description of a typographic characteristic included in the training image than a user could provide. Additionally, in some cases, by generating the training description using the machine learning model, the image generation system is able to produce a set of training data of an appropriately large size for training the image generation network to generate images having specific typographic characteristics using the training data.

An example of the present disclosure is used in an image generation context. In the example, a user wants to generate a logo for a dentistry practice, where the logo includes the text element “Smile” rendered with a typographic characteristic of a Cooper Std Black font. The user provides the prompt “a dentistry logo, Smile text rendered with font CooperStdBlack” to the image generation system.

In response to the prompt, an image generation network of the image generation system generates an image that realistically and accurately depicts a tooth above the word “Smile” rendered in a Cooper Std Black font and provides the image to the user. Because the image generation network is trained based on a typographically aware training description for a training image, where the typographically aware training description is generated by the image generation system using a machine learning model, the image generation network is itself trained to be typographically aware and is therefore able to generate an image that better depicts a user-specified typographic characteristic than conventional image generation models can provide.

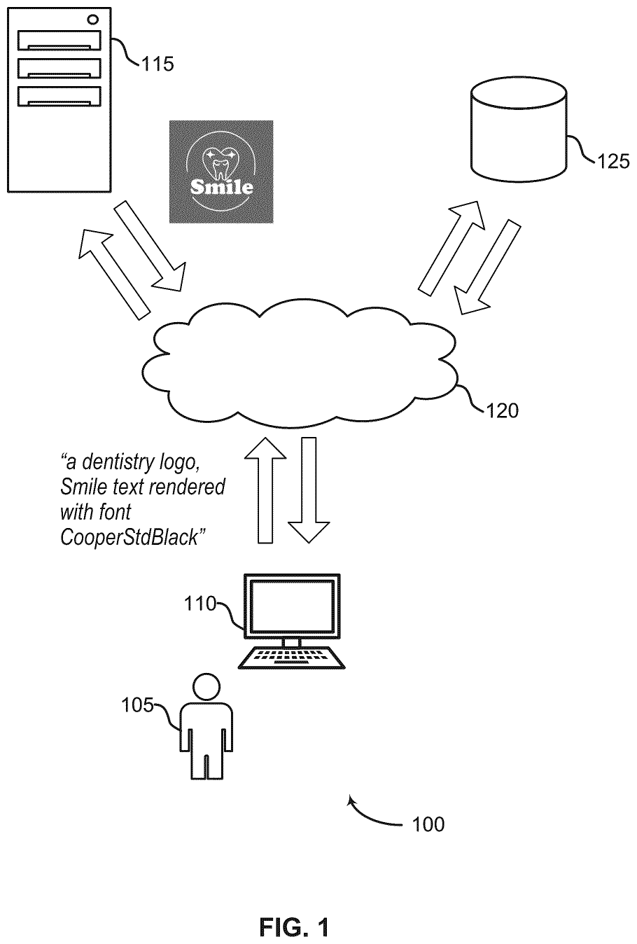

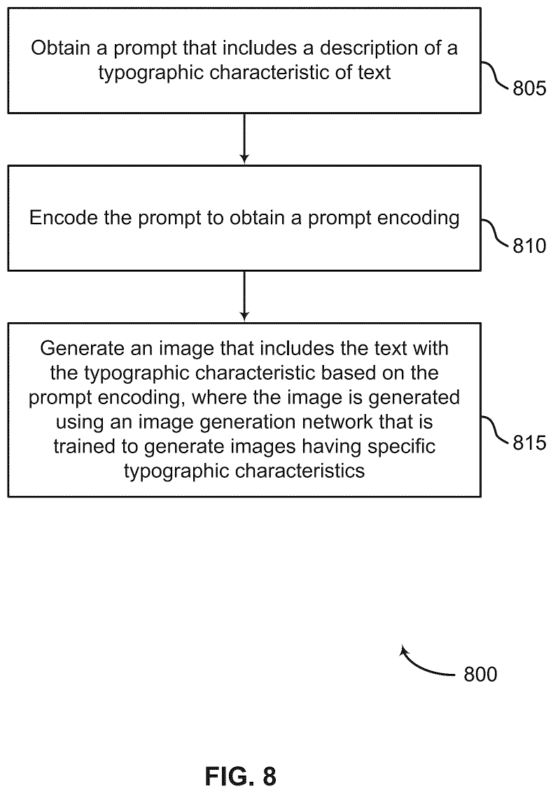

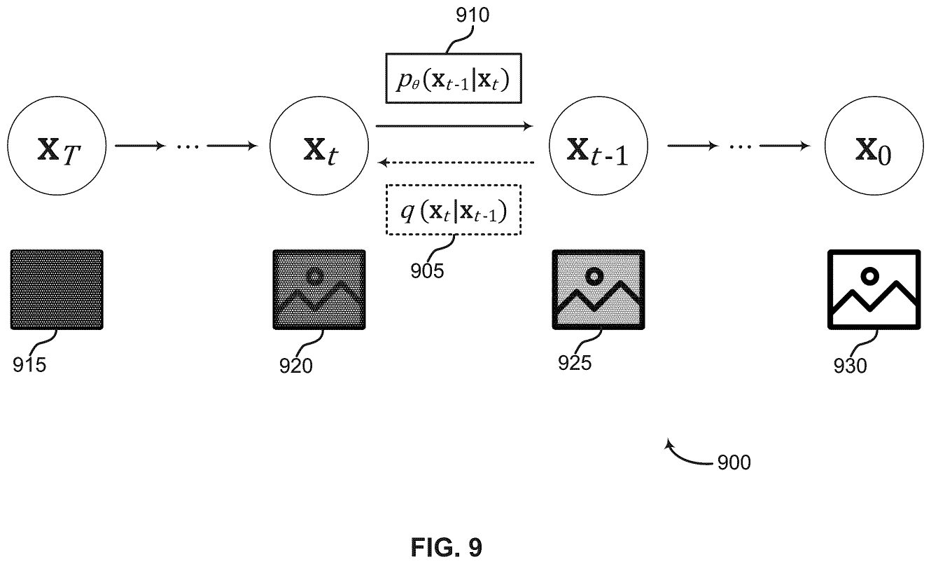

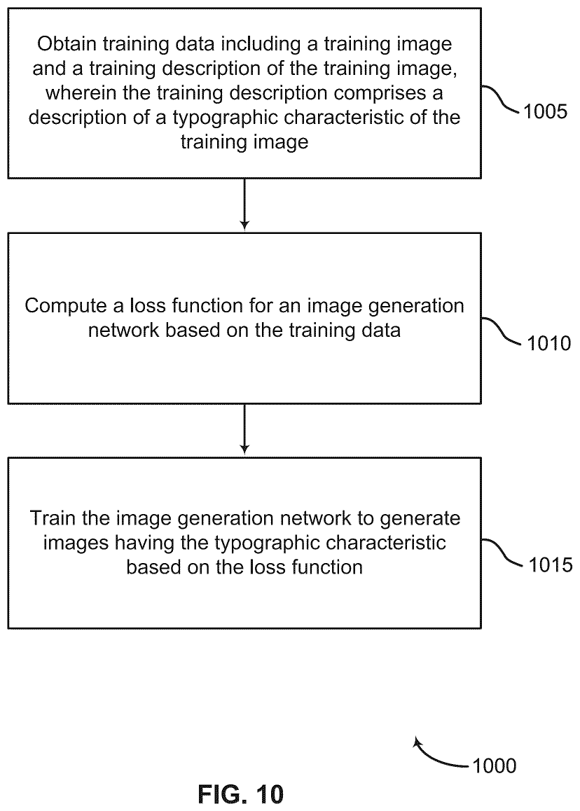

Further example applications of the present disclosure in the image generation context are provided with reference to FIGS. 1-4. Details regarding the architecture of the image generation system are provided with reference to FIGS. 1-7 and 15. Details regarding a process for image generation are provided with reference to FIGS. 8-9. Details regarding a process for training an image generation network are provided with reference to FIGS. 10-14.

According to some aspects of the present disclosure, an image generation system provides a typographically aware image generation network that is able to generate an image that depicts a specific typographic characteristic more accurately and realistically than conventional image generation models and in a more efficient manner than manually creating a comparable image. According to some aspects of the present disclosure, the image generation system is able to obtain training data, including a training image and a training description, for training the image generation network to be typographically aware, where the training description is more descriptive of a typographic characteristic of the training image than existing training descriptions of training images.

### Image Generation System

A system and an apparatus for typographically aware image generation is described with reference to FIGS. 1-7 and 15. One or more aspects of the system and the apparatus include one or more processors; one or more memory components coupled with the one or more processors; and an image generation network comprising parameters stored in the one or more memory components and trained to generate images having specific typographic characteristics, wherein the image generation network is trained using a training image and a training description of a text element of the training image. In some aspects, the image generation network is a text-guided diffusion model.

Some examples of the system and the apparatus further include a multimodal text generation model trained to generate the training description of the training image based on the training image. Some examples of the system and the apparatus further include a text recognition component configured to perform text recognition on the training image to obtain text data, wherein the training description is generated based on the text data.

Some examples of the system and the apparatus further include a font encoder configured to encode the text data to obtain a font encoding, wherein the training description is generated based on the font encoding. Some examples of the system and the apparatus further include a text style encoder configured to encode the text data to obtain a text style encoding, wherein the training description is generated based on the text style encoding.

Some examples of the system and the apparatus further include an object detection component configured to detect an object included in the training image and to generate an object encoding based on the object, wherein the training description is generated based on the object encoding. Some examples of the system and the apparatus further include a text combination model configured to generate the training description based on a description of the training image and a description of the text element.

FIG. 1 shows an example of an image generation system 100 according to aspects of the present disclosure. The example shown includes user 105, user device 110, image generation apparatus 115, cloud 120, and database 125.

Referring to FIG. 1, user 105 provides a text prompt describing an image including specific typographic characteristics (e.g., “a dentistry logo, Smile text rendered with font CooperStdBlack”) to image generation apparatus 115 via user device 110. In some cases, user 105 provides the text prompt to image generation apparatus 115 via a user interface provided on user device 110 by image generation apparatus 115.

As shown in FIG. 1, image generation apparatus 115 generates an image based on the text prompt including the specific typographic characteristics specified by the text prompt (e.g., an image depicting the word “Smile” rendered with Cooper Std Black font, as well as the prediction of image generation apparatus 115 for “dentistry logo”). Image generation apparatus 115 provides the image to user 105 via user device 110 (for example, via the user interface provided on user device 110).

In some cases, a “typographic characteristic” refers to one or more of a location of text within an image, a font of the text, a size of the text, a justification of the text, a color of the text, or a style for the text (e.g., an identification of the text as being a heading, a subheading, a body, a title, etc.).

In some cases, “typographically aware” can refer to either a quality of a training description that helps an image generation model to learn to generate images having typographic characteristics specified by an input prompt, or a quality of an image generation model that is trained to generate an image having a typographic characteristic specified by an input prompt.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image generation apparatus 115. In some aspects, the user interface allows information (such as an image, a prompt, etc.) to be communicated between user 105 and image generation apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

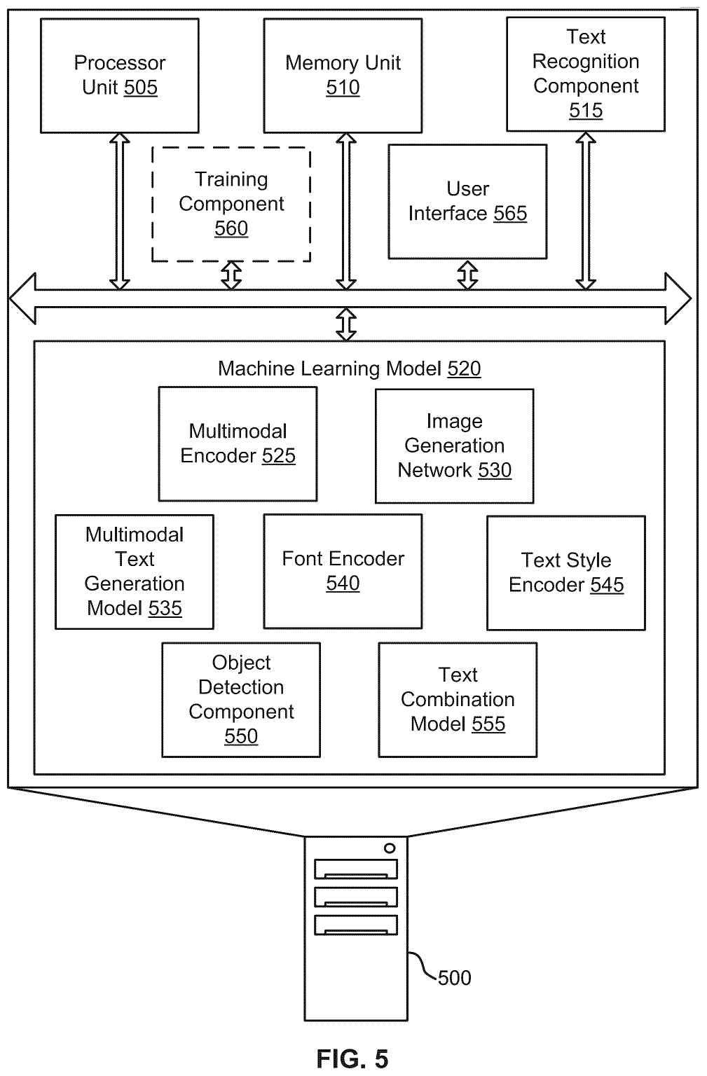

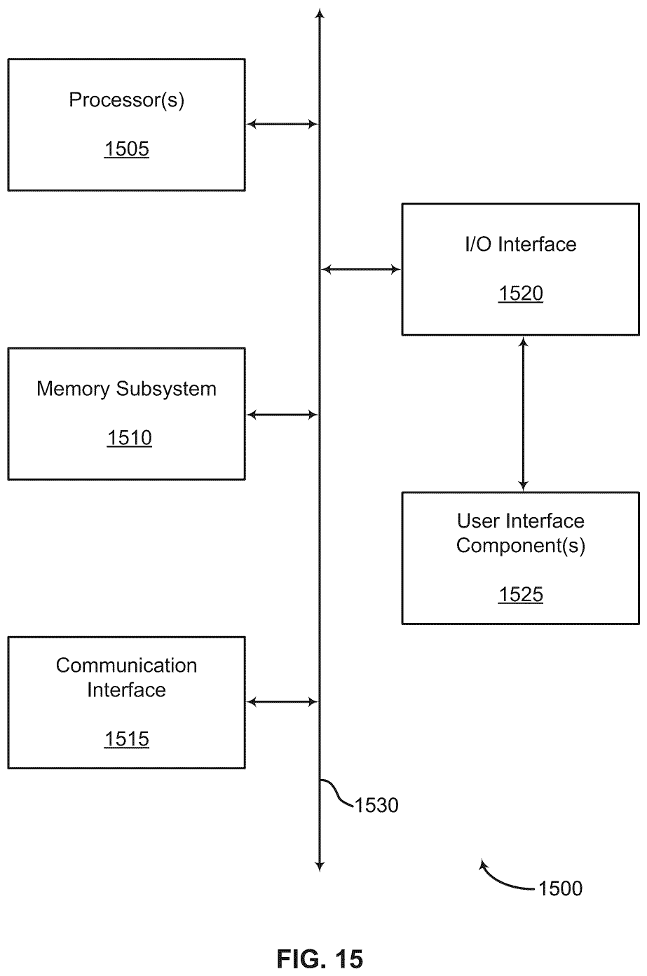

Image generation apparatus 115 is an example of, or includes aspects of, the corresponding element described with reference to FIGS. 5 and 11-13. According to some aspects, image generation apparatus 115 includes a computer-implemented network. In some embodiments, the computer-implemented network includes a machine learning model (such as the machine learning model described with reference to FIG. 5). In some embodiments, image generation apparatus 115 also includes one or more processors, a memory subsystem, a communication interface, an I/O interface, one or more user interface components, and a bus as described with reference to FIG. 15. Additionally, in some embodiments, image generation apparatus 115 communicates with user device 110 and database 125 via cloud 120.

In some cases, image generation apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of image generation apparatus 115 is provided with reference to FIGS. 5-7 and 15. Further detail regarding a process for image generation is provided with reference to FIGS. 8-9. Further detail regarding a process for training a machine learning model is provided with reference to FIGS. 10-14.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, image generation apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image generation apparatus 115 and communicates with image generation apparatus 115 via cloud 120. According to some aspects, database 125 is included in image generation apparatus 115.

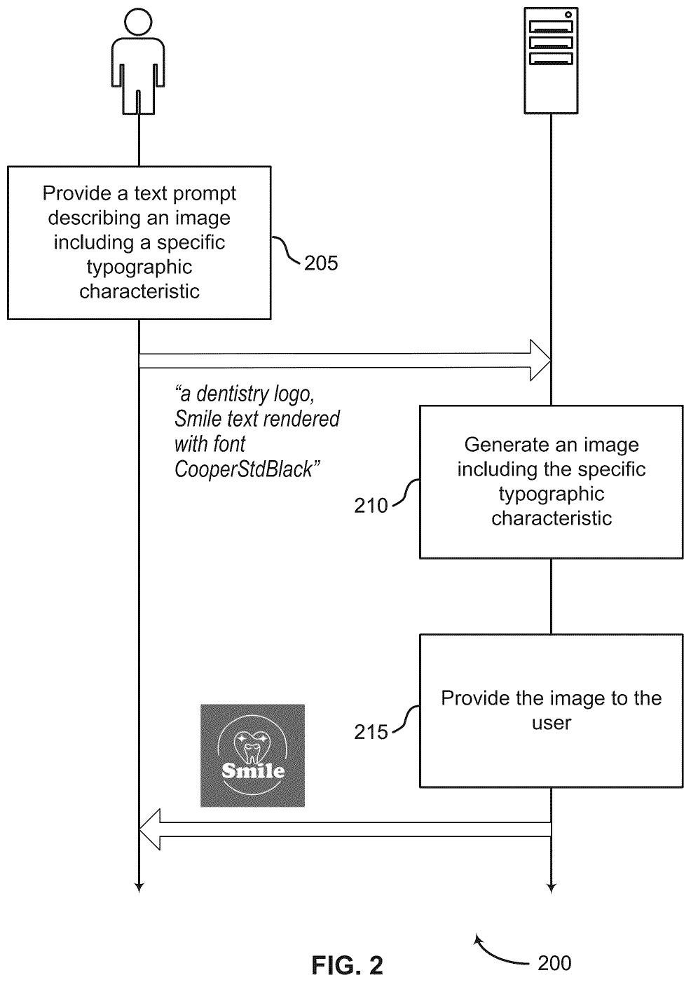

FIG. 2 shows an example of a method 200 for generating a typographically aware image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user provides a text prompt describing an image including specific typographic characteristics (e.g., “a dentistry logo, Smile text rendered with font CooperStdBlack”) to an image generation apparatus (such as the image generation apparatus described with reference to FIGS. 1, 5, and 11-13). In some cases, the image generation apparatus uses an image generation network that is trained by the image generation system to be typographically aware to generate an image based on the text prompt including a typographic characteristic specified by the text prompt (e.g., an image depicting the word “Smile” rendered with Cooper Std Black font, where the specific font is the specific typographic characteristic, as well as the prediction of image generation apparatus 115 for “dentistry logo”). The image generation apparatus provides the image to the user.

At operation 205, the user provides a text prompt describing an image including a specific typographic characteristic. In some cases, the operations of this step refer to, or may be performed by, a user as described with reference to FIG. 1. For example, in some cases, the user provides the text prompt to the image generation apparatus via a user interface (such as a graphical user interface) provided on a user device by the image generation apparatus.

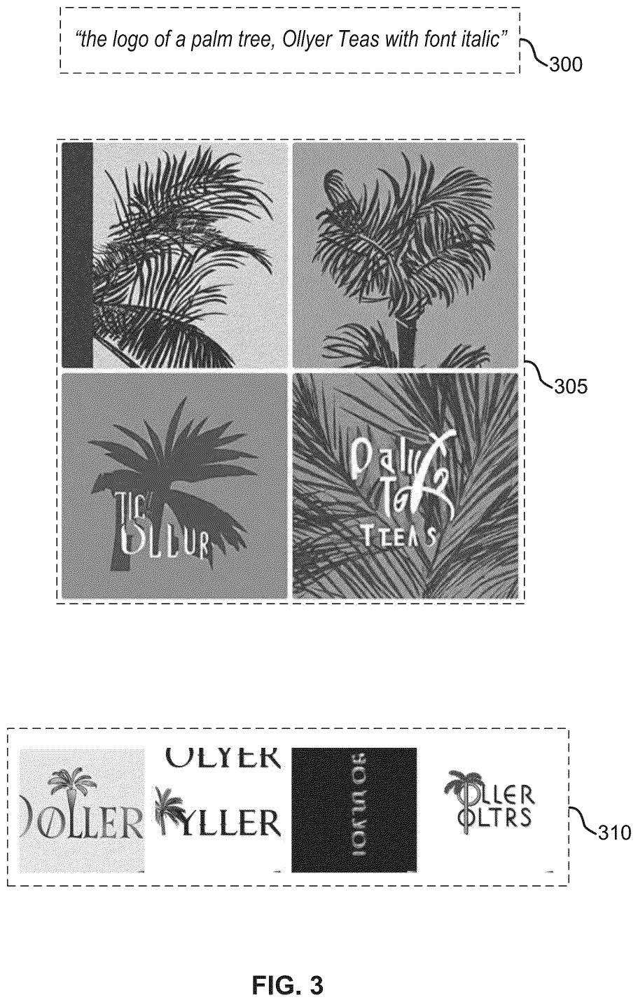

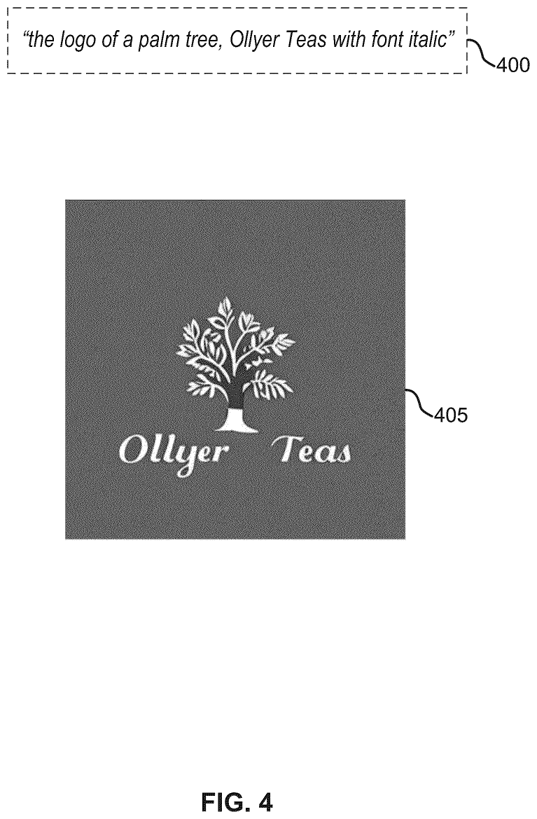

At operation 210, the system generates an image including the specific typographic characteristic. In some cases, the operations of this step refer to, or may be performed by, an image generation apparatus as described with reference to FIGS. 1, 5, and 11-13. For example, the system may generate the image using an image generation network as described with reference to FIGS. 8-9. An example of an image generated by the image generation network is described with reference to FIG. 4. Examples of comparative images generated by comparative machine learning models are described with reference to FIG. 3. In some cases, the image generation network is trained as described with reference to FIGS. 10-14.

At operation 215, the system provides the image to the user. In some cases, the operations of this step refer to, or may be performed by, an image generation apparatus as described with reference to FIGS. 1, 5, and 11-13. For example, in some cases, the image generation apparatus provides the image to the user via the user interface provided on the user device by the image generation apparatus.

FIG. 3 shows an example of comparative generated images. The example shown includes prompt 300, first set of comparative images 305, and second set of comparative images 310. Prompt 300 is an example of, or includes aspects of, the corresponding element described with reference to FIG. 4.

Referring to FIG. 3, first set of comparative images 305 includes images generated by a comparative text-based diffusion model based on prompt 300 and second set of comparative images 310 includes images generated by a comparative transformer-based text-to-image machine learning model based on prompt 300. As shown in FIG. 3, each of first set of comparative images 305 and second set of comparative images 310 fails to include an image including text and a typographic characteristic specified by prompt 300 (the specific words “Ollyer Teas” rendered in an italic font).

Both the comparative text-based diffusion model and the comparative transformer-based text-to-image machine learning model fail to generate an image comprising a typographic characteristic specified by a prompt because they have not been trained to be typographically aware due to a lack of appropriate training data.

For example, existing training data sets for comparative text-based image generation machine learning models comprise pairs of training images and training descriptions of the training images, where the comparative text-based image generation machine learning models learn to generate images based on the training descriptions such that the generated images look like the training images.

However, existing training data sets for comparative text-based image generation machine learning models do not include either training descriptions that are sufficiently descriptive of typographic characteristics of training images or a sufficiently large number of training description and training image pairs for the comparative text-based image generation machine learning models to learn to be typographically aware (e.g., able to generate an image including a specific text characteristic).

FIG. 4 shows an example of an image 405 generated by the image generation system according to aspects of the present disclosure. The example shown includes prompt 400 and image 405. Prompt 400 is an example of, or includes aspects of, the corresponding element described with reference to FIG. 3.

Referring to FIG. 4, an image generation network (such as the image generation network described with reference to FIG. 5) generates image 405 including text (the words “Ollyer Teas”) and a typographic characteristic (an italic font) specified by prompt 400, as well as other visual characteristics (“the logo of a palm tree”) specified by prompt 400. As shown in FIG. 4, the text and the visual characteristics of image 405 are arranged in a realistic and visually appealing manner. Prompt 400 is the same as the prompt shown in FIG. 3.

In some cases, the image generation network is typographically aware (e.g., able to generate an image including a specific typographic characteristic) because it has been trained based on training data provided by the image generation apparatus. An example of a process for obtaining the training data and training the image generation network based on the training data is described with reference to FIGS. 10-14.

FIG. 5 shows an example of an image generation apparatus 500 according to aspects of the present disclosure. Image generation apparatus 500 is an example of, or includes aspects of, the corresponding element described with reference to FIGS. 1 and 11-13. In one aspect, image generation apparatus 500 includes processor unit 505, memory unit 510, machine learning model 520, user interface 565, training component 560, and text recognition component 515.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 505 is configured to operate a memory array using a memory controller. In other cases, a memory controller is integrated into processor unit 505. In some cases, processor unit 505 is configured to execute computer-readable instructions stored in memory unit 510 to perform various functions. In some aspects, processor unit 505 includes special purpose components for modem processing, baseband processing, digital signal processing, or transmission processing. According to some aspects, processor unit 505 comprises the one or more processors described with reference to FIG. 15.

Memory unit 510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 510 includes a basic input/output system (BIOS) that controls basic hardware or software operations, such as an interaction with peripheral components or devices. In some cases, memory unit 510 includes a memory controller that operates memory cells of memory unit 510. For example, the memory controller may include a row decoder, column decoder, or both. In some cases, memory cells within memory unit 510 store information in the form of a logical state. According to some aspects, memory unit 510 comprises the memory subsystem described with reference to FIG. 15.

According to some aspects, image generation apparatus 500 uses at least one processor included in processor unit 505 to execute instructions stored in at least one memory device included in memory unit 510 to perform operations.

For example, according to some aspects, image generation apparatus 500 obtains a prompt that includes a description of a typographic characteristic of text. In some aspects, the typographic characteristic includes at least one of a font, a text size, a text justification, and a color. In some aspects, the prompt includes a visual description of the image and a description of a location of the text within the image. In some examples, image generation apparatus 500 receives the prompt from a user via a graphical user interface. In some examples, image generation apparatus 500 provides the image to the user via the graphical user interface in response to receiving the prompt. In some examples, image generation apparatus 500 obtains a noise image.

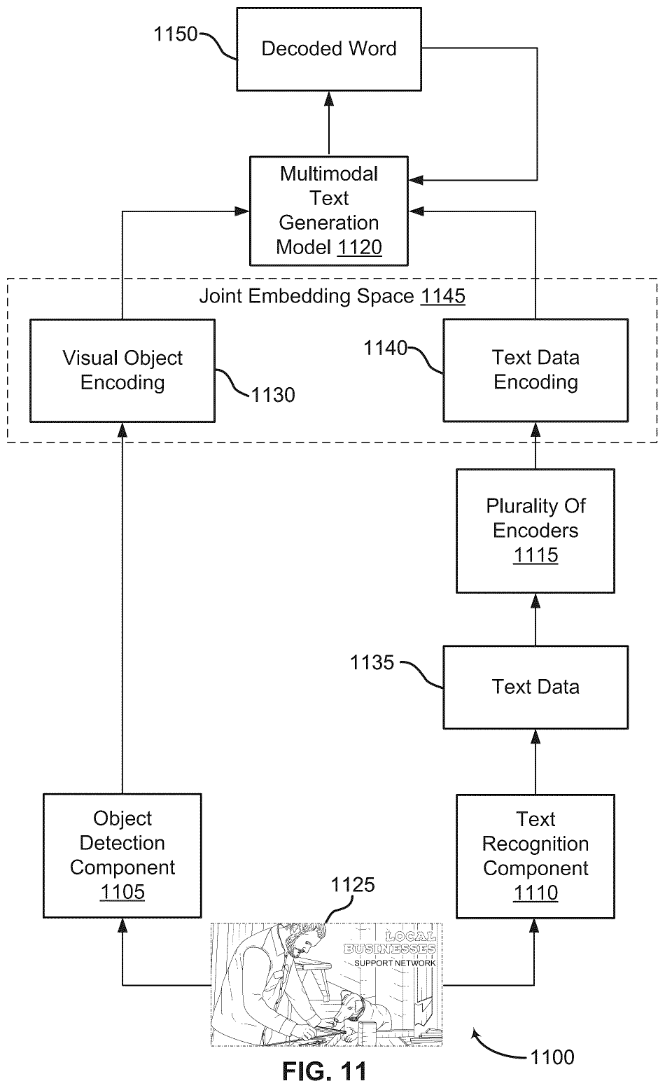

Text recognition component 515 is an example of, or includes aspects of, the corresponding element described with reference to FIG. 11. According to some aspects, text recognition component 515 is implemented as software stored in memory unit 510 and executable by processor unit 505, as firmware, as one or more hardware circuits, or as a combination thereof.

According to some aspects, text recognition component 515 performs text recognition on a training image to obtain text data, where the multimodal text generation model 535 takes the text data as an input. According to some aspects, text recognition component 515 is configured to perform text recognition on the training image to obtain text data, wherein the training description is generated based on the text data. In some cases, the text data comprises at least one of a word or words comprised in a text, a location of the text, a font of the text, and a text style of the text. In some cases, the text data is comprised in text recognition token. In some cases, text recognition component 515 outputs the text recognition token comprising the text data in response to the text recognition.

In some cases, text recognition component 515 is configured to perform an optical character recognition process on an image to obtain the text data using a combination of image processing and pattern recognition.

In one aspect, machine learning model 520 includes multimodal encoder 525, image generation network 530, multimodal text generation model 535, font encoder 540, text style encoder 545, object detection component 550, and text combination model 555.

According to some aspects, machine learning model 520 comprises machine learning parameters stored in memory unit 510. Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a strength of connections between neurons and influence the neural network's ability to capture complex patterns in data.

According to some aspects, machine learning model 520 is implemented as software stored in memory unit 510 and executable by processor unit 505, as firmware, as one or more hardware circuits, or as a combination thereof.

According to some aspects, machine learning model 520 comprises one or more ANNs. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

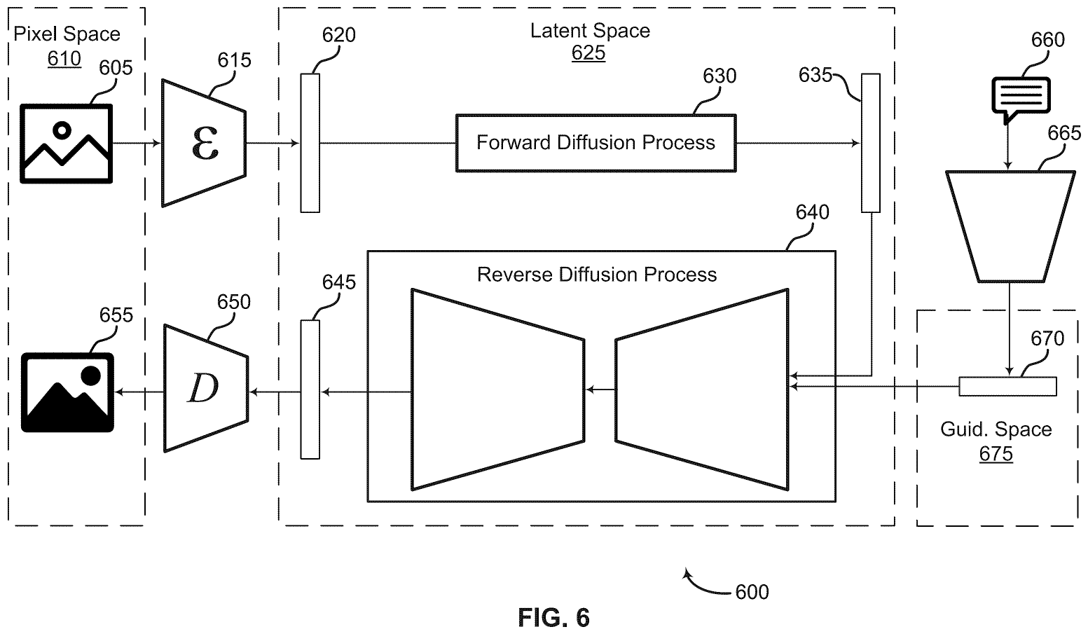

Multimodal encoder 525 is an example of, or includes aspects of, the corresponding element described with reference to FIG. 6. According to some aspects, multimodal encoder 525 comprises multimodal encoder parameters stored in memory unit 510. According to some aspects, multimodal encoder 525 is implemented as software stored in memory unit 510 and executable by processor unit 505, as firmware, as one or more hardware circuits, or as a combination thereof.

According to some aspects, multimodal encoder 525 comprises one or more ANNs trained to process and represent information from multiple modalities, such as text, images, audio, or other types of data. In some cases, multimodal encoder 525 combines information from different modalities into a unified representation that can be further used for downstream tasks like classification, generation, or retrieval.

In some cases, multimodal encoder 525 is implemented as a fusion-based multimodal encoder that aims to integrate information from different modalities by combining their representations. For example, in some cases, multimodal encoder 525 comprises a convolutional neural network (CNN) for encoding visual information and a recurrent neural network (RNN) or transformer for encoding textual information. Multimodal encoder 525 can then concatenate, average, or weight the outputs from both modalities to obtain a joint representation in a joint embedding space.

A CNN is a class of ANN that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

A recurrent neural network (RNN) is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

In some cases, multimodal encoder 525 comprises an attention mechanism to selectively focus on relevant information from each modality by computing weighted combinations of the modalities' features based on their importance. By attending to the most relevant parts of each modality, multimodal encoder 525 can effectively capture the interactions between them.

An attention mechanism is a key component in some ANN architectures, particularly ANNs employed in natural language processing (NLP) and sequence-to-sequence tasks, that allows an ANN to focus on different parts of an input sequence when making predictions or generating output. NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

Some sequence models (such as RNNs) process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN can dynamically allocate attention to different parts of the input sequence, allowing the ANN to focus on relevant information and capture dependencies across longer distances.

According to some aspects, multimodal encoder 525 comprises one or more ANNs that are trained, designed, and/or configured to encode the prompt to obtain a prompt encoding. According to some aspects, multimodal encoder 525 is an example of, or includes aspects of, the corresponding element described with reference to FIG. 6. In some cases, the prompt encoding is obtained in a text embedding space. In some cases, the prompt encoding is obtained in a guidance space as described with reference to FIG. 6.

According to some aspects, image generation network 530 comprises image generation parameters stored in memory unit 510. According to some aspects, image generation network 530 is implemented as software stored in memory unit 510 and executable by processor unit 505, as firmware, as one or more hardware circuits, or as a combination thereof.

According to some aspects, image generation network 530 comprises one or more ANNs that are trained, designed, and/or configured to generate an image that includes the text with the typographic characteristic based on the prompt encoding. For example, in some cases, image generation network 530 comprises a diffusion model.

A diffusion model is a class of ANN that is trained to generate an image by learning an underlying probability distribution of the training data that allows the model to iteratively refine the generated image using a series of diffusion steps. In some cases, a reverse diffusion process of the diffusion model starts with a noise vector or a randomly initialized image. In each diffusion step of the reverse diffusion process, the model applies a sequence of transformations (such as convolutions, up-sampling, down-sampling, and non-linear activations) to the image, gradually “diffusing” the original noise or image to resemble a real sample. During the reverse diffusion process, the diffusion model estimates the conditional distribution of the next image given the current image (for example, using a CNN or a similar architecture).

In some examples, image generation network 530 removes noise from the noise image based on the prompt encoding to obtain the image. In some cases, image generation network 530 is trained to generate images having specific typographic characteristics. In some aspects, the image generation network 530 is trained using a training image and a training description of a text element of the training image.

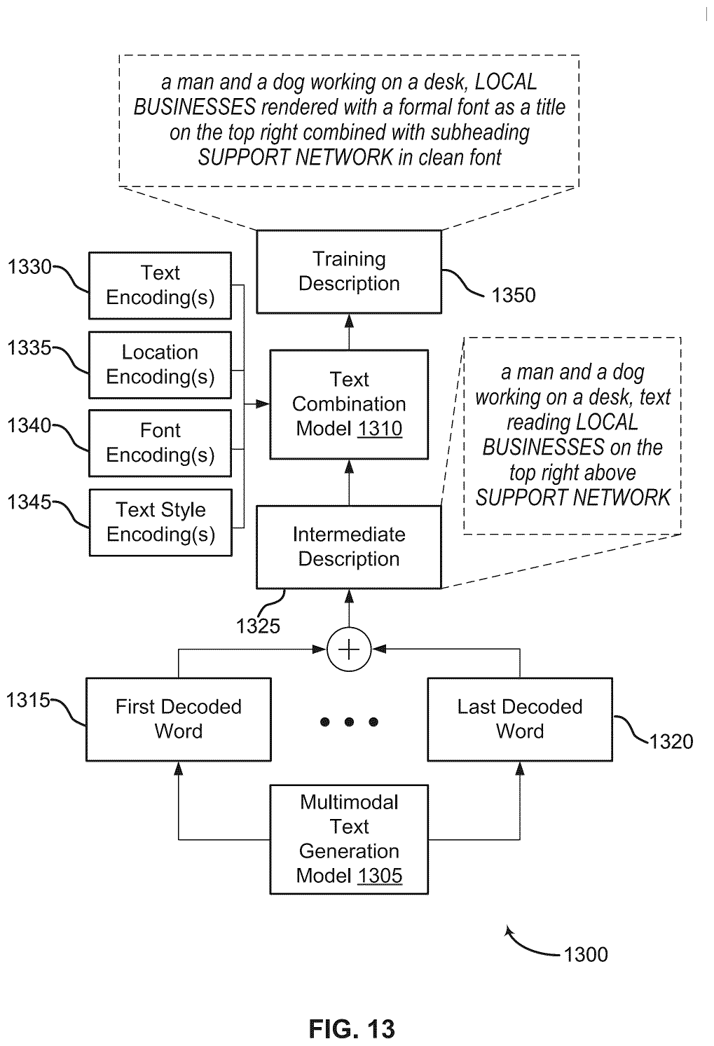

Multimodal text generation model 535 is an example of, or includes aspects of, the corresponding element described with reference to FIGS. 11 and 13. According to some aspects, multimodal text generation model 535 comprises multimodal text generation parameters stored in memory unit 510. According to some aspects, multimodal text generation model 535 is implemented as software stored in memory unit 510 and executable by processor unit 505, as firmware, as one or more hardware circuits, or as a combination thereof.

According to some aspects, multimodal text generation model 535 comprises one or more ANNs that are trained, designed, and/or configured to generate a training description of a training image based on the training image. In some cases, multimodal text generation model 535 comprises a transformer-based model trained to generate a description (e.g., the training description of an image (e.g., the training image) that is typographically aware (e.g., communicative of a typographic characteristic of text included in the image). According to some aspects, multimodal text generation model 535 is trained to generate an intermediate description.

For example, in some cases, multimodal text generation model 535 comprises one or more multimodal transformer layers comprising one or more transformers. In some cases, a transformer comprises one or more ANNs comprising attention mechanisms that enable the transformer to weigh an importance of different words or tokens within a sequence. A transformer can process entire sequences simultaneously in parallel, making the transformer highly efficient and allowing the transformer to capture long-range dependencies more effectively.

In some cases, a transformer comprises an encoder-decoder structure. In some cases, the encoder of the transformer processes an input sequence and encodes the input sequence into a set of high-dimensional representations. In some cases, the decoder of the transformer generates an output sequence based on the encoded representations and previously generated tokens. In some cases, the encoder and the decoder are composed of multiple layers of self-attention mechanisms and feed-forward ANNs.

In some cases, the self-attention mechanism allows the transformer to focus on different parts of an input sequence while computing representations for the input sequence. The self-attention mechanism can capture relationships between words of a sequence by assigning attention weights to each word based on a relevance to other words in the sequence, thereby enabling the transformer to model dependencies regardless of a distance between words.

In some cases, multimodal text generation model 535 comprises a pointer network. In some cases, a pointer network comprises one or more ANNs trained to learn a conditional probability of an output sequence with elements that are discrete tokens corresponding to positions in an input sequence. In some cases, the pointer network provides a mechanism for selecting text in an image in a permutation-invariant manner without using ad-hoc position indices.

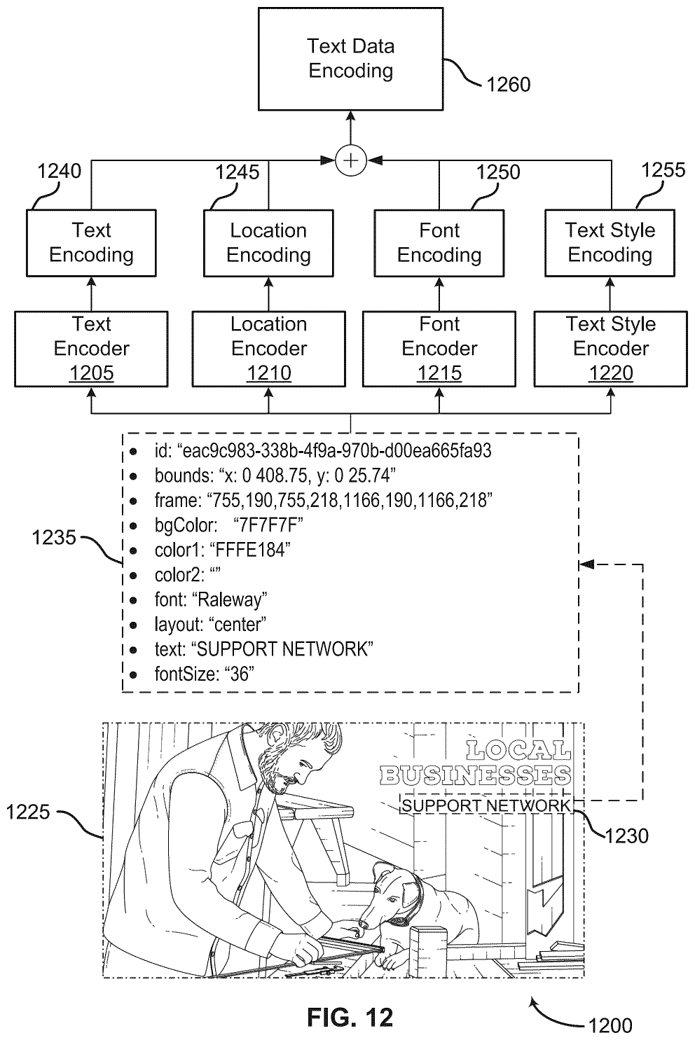

Font encoder 540 is an example of, or includes aspects of, the corresponding element described with reference to FIG. 12. According to some aspects, font encoder 540 comprises font encoding parameters stored in memory unit 510. According to some aspects, font encoder 540 is implemented as software stored in memory unit 510 and executable by processor unit 505, as firmware, as one or more hardware circuits, or as a combination thereof.

According to some aspects, font encoder 540 comprises one or more ANNs (such as a CNN) that are trained, designed, and/or configured to encode the text data to obtain a font encoding, wherein the training description is generated based on the font encoding. According to some aspects, font encoder 540 encodes the text data to obtain a font encoding, where multimodal text generation model 535 takes the font encoding as an input.

Text style encoder 545 is an example of, or includes aspects of, the corresponding element described with reference to FIG. 12. According to some aspects, text style encoder 545 comprises text style encoding parameters stored in memory unit 510. According to some aspects, text style encoder 545 is implemented as software stored in memory unit 510 and executable by processor unit 505, as firmware, as one or more hardware circuits, or as a combination thereof.

According to some aspects, text style encoder 545 comprises one or more ANNs (such as a CNN) that are trained, designed, and/or configured to encode the text data to obtain a text style encoding, wherein the training description is generated based on the text style encoding. In some cases, a “text style” refers to a style of an element of text, such as whether the element is a heading, a subheading, a body, a title, etc.

Object detection component 550 is an example of, or includes aspects of, the corresponding element described with reference to FIG. 11. According to some aspects, object detection component 550 comprises object detection parameters stored in memory unit 510. According to some aspects, object detection component 550 is implemented as software stored in memory unit 510 and executable by processor unit 505, as firmware, as one or more hardware circuits, or as a combination thereof.

According to some aspects, object detection component 550 comprises one or more ANNs (such as a CNN) that are trained, designed, and/or configured to detect an object included in the training image and to generate an object encoding based on the object, wherein the training description is generated based on the object encoding.

In some cases, object detection component 550 is implemented as a Faster R-CNN (region-based convolutional neural network). A Faster R-CNN is an object detection algorithm that combines deep learning with region proposal methods.

A Faster R-CNN can comprise a CNN backbone, a region proposal network (RPN), and a region-based classifier. The CNN backbone may be a pre-trained network that extracts features from an input image. The backbone processes the image and produces a feature map that encodes the visual information.

The RPN operates on top of the feature map generated by the CNN backbone. The RPN is responsible for proposing potential object bounding box regions in the image. The RPN scans the feature map using sliding windows of different sizes and aspect ratios, predicting the probability of an object being present and adjusting the coordinates of the proposed bounding boxes. The RPN outputs a set of region proposals along with corresponding objectness scores. These proposals are then refined using non-maximum suppression (NMS) to filter-out highly overlapping bounding boxes and keeps the most confident ones.

The refined region proposals are fed into the region-based classifier. The region-based classifier uses ROI (Region of Interest) pooling or similar techniques to extract fixed-size feature vectors from each region proposal. The fixed-size feature vectors are then fed into a classifier, typically a fully connected network, to predict class labels and refine the bounding box coordinates for each proposed region.

During training, the Faster R-CNN is trained end-to-end using a multi-task loss function. This loss function combines a classification loss (e.g., a cross-entropy loss) and a bounding box regression loss (e.g., a smooth L1 loss) to jointly optimize the Faster R-CNN for accurate object classification and precise localization.

Text combination model 555 is an example of, or includes aspects of, the corresponding element described with reference to FIG. 13. According to some aspects, text combination model 555 comprises text combination parameters stored in memory unit 510. According to some aspects, text combination model 555 is implemented as software stored in memory unit 510 and executable by processor unit 505, as firmware, as one or more hardware circuits, or as a combination thereof.

According to some aspects, text combination model 555 comprises one or more ANNs (such as a transformer) that are trained, designed, and/or configured to generate the training description based on a description of the training image and a description of the text element.

According to some aspects, text combination model 555 generates the training description based on the intermediate description and the text data. According to some aspects, text combination model 555 is comprised in multimodal text generation model 535.

In some cases, text combination model 555 comprises a transformer-based language model. A language model is a computational model or algorithm designed to understand, generate, and predict human language. In some cases, an ANN that implements a language model is trained on a large amount of text data to learn statistical patterns and relationships between words and phrases. Language models are fundamental components in many natural language processing (NLP) tasks, such as machine translation, speech recognition, text generation, sentiment analysis, and more.

In some cases, text recognition component 515 is included in machine learning model 520. In some cases, text recognition component 515 comprises one or more ANNs and implements the optical character recognition process using one or more machine learning algorithms.

According to some aspects, training component 560 is implemented as software stored in memory unit 510 and executable by processor unit 505, as firmware, as one or more hardware circuits, or as a combination thereof.

In some cases, training component 560 is omitted from image generation apparatus 500 and included in a separate apparatus, where training component 560 communicates with image generation apparatus 500 to perform the training functions described herein. In some cases, training component 560 is implemented as software stored in a memory unit of the separate apparatus and executable by a processor unit of the separate apparatus, as firmware of the separate apparatus, as one or more hardware circuits of the separate apparatus, or as a combination thereof.

According to some aspects, training component 560 obtains training data including a training image and a training description of the training image. In some examples, the training description comprises a description of a typographic characteristic of the training image. In some examples, the training description comprises a description of a typographic characteristic of a text element of the training image. In some examples, training component 560 computes a loss function for image generation network 530 based on the training data. In some examples, training component 560 trains image generation network 530 to generate images having the typographic characteristic based on the loss function.

According to some aspects, user interface 565 provides for communication between a user device (such as the user device described with reference to FIG. 1) and image generation apparatus 500. For example, in some cases, user interface 565 is a graphical user interface (GUI) provided on the user device by image generation apparatus 500.

FIG. 6 shows an example of a guided latent diffusion architecture 600 according to aspects of the present disclosure. As shown in FIG. 6, an image generation network (such as the image generation network described with reference to FIG. 5) can be implemented as a diffusion model (e.g., a latent diffusion model).

Diffusion models are a class of generative ANNs that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that a same input results in a same output. Diffusion models may also be characterized by whether noise is added to an image itself, or to image features generated by an encoder, as in latent diffusion.

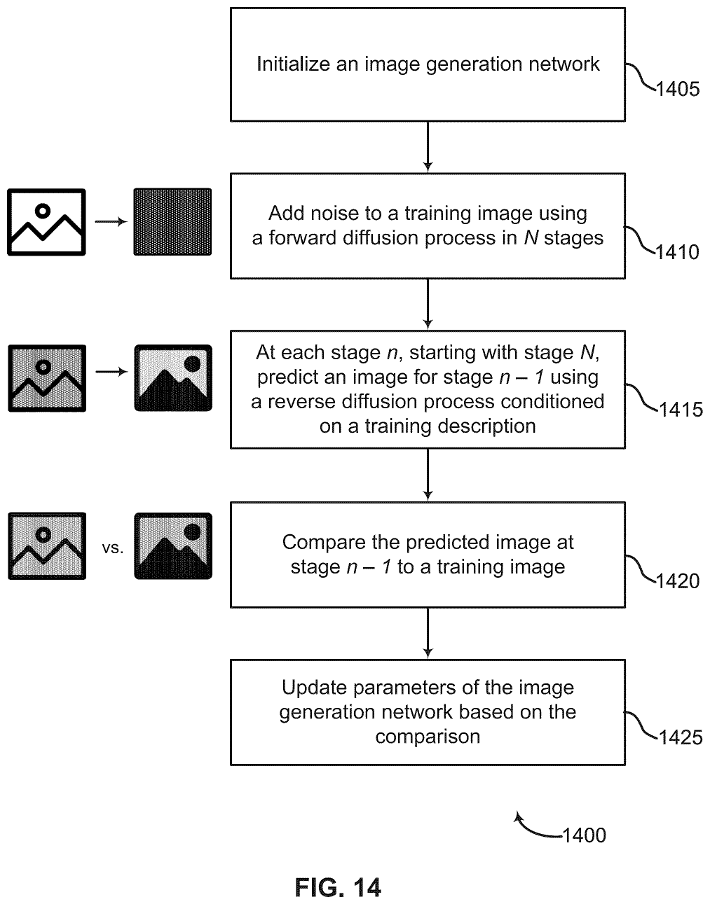

Referring to FIG. 6, according to some aspects, an image encoder (e.g., image encoder 615) of an image generation apparatus (such as the image generation apparatus described with reference to FIGS. 1, 5, and 11-13) encodes original image 605 from pixel space 610 and generates original image features 620 in latent space 625. According to some aspects, the image generation apparatus uses forward diffusion process 630 to gradually add noise to original image features 620 to obtain noisy features 635 (also in latent space 625) at various noise levels. In some cases, forward diffusion process 630 is implemented as the forward diffusion process described with reference to FIG. 9 or 14. In some cases, for example in a training context, forward diffusion process 630 is implemented by a training component described with reference to FIG. 5.

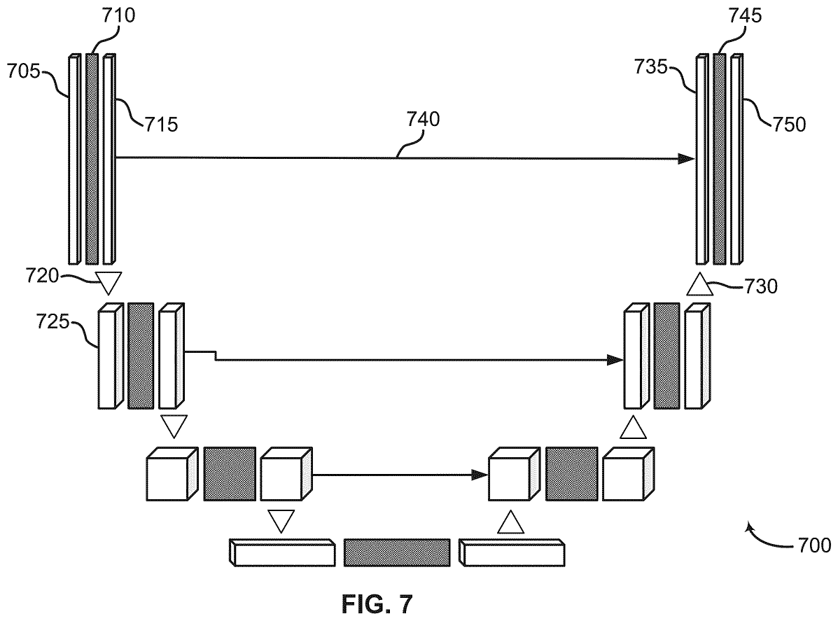

According to some aspects, the image generation network applies reverse diffusion process 640 to noisy features 635 to gradually remove the noise from noisy features 635 at the various noise levels to obtain denoised image features 645 in latent space 625. In some cases, reverse diffusion process 640 is implemented as the reverse diffusion process described with reference to FIG. 9 or 14. In some cases, reverse diffusion process 640 is implemented by a U-Net ANN comprised in the image generation network and described with reference to FIG. 7.

According to some aspects, a training component (such as the training component described with reference to FIG. 5) compares denoised image features 645 to original image features 620 at each of the various noise levels and updates the image generation parameters of the image generation network based on the comparison. In some cases, an image decoder (e.g., image decoder 650) comprised in the image generation apparatus decodes denoised image features 645 to obtain output image 655 in pixel space 610. In some cases, an output image 655 is created at each of the various noise levels. In some cases, the training component compares output image 655 to original image 605 to train the image generation network. Output image 655 is an example of, or includes aspects of, the image described with reference to FIGS. 1-2 and 4.

In some cases, image encoder 615 and image decoder 650 are pretrained prior to training the image generation network. In some examples, image encoder 615, image decoder 650, and the image generation network are jointly trained. In some cases, image encoder 615 and image decoder 650 are jointly fine-tuned with the image generation network.

According to some aspects, reverse diffusion process 640 is guided based on a guidance prompt such as text prompt 660 (e.g., a prompt described with reference to FIG. 4 or a training description described with reference to FIGS. 10-13). In some cases, text prompt 660 is encoded using multimodal encoder 665 to obtain guidance features 670 in guidance space 675. Multimodal encoder 665 is an example of, or includes aspects of, the corresponding element described with reference to FIG. 5.

In some cases, guidance features 670 are combined with noisy features 635 at one or more layers of reverse diffusion process 640 to ensure that output image 655 includes content described by text prompt 660. For example, in some cases, the guidance prompt provides conditioning for the image generation network. In the context of a diffusion model, “conditioning” refers to a process of incorporating additional context into the predictions of the diffusion model to generate an output that relates to the context.

For example, guidance features 670 can be combined with noisy features 635 using a cross-attention block within reverse diffusion process 640. Cross-attention, also known as multi-head attention, is an extension of the attention mechanism used in some ANNs for NLP tasks. Cross-attention enables reverse diffusion process 640 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 640 to better understand the context and generate more accurate and contextually relevant outputs.

FIG. 7 shows an example of a U-Net 700 according to aspects of the present disclosure. According to some aspects, an image generation network (such as the image generation network described with reference to FIG. 5) comprises an ANN architecture known as a U-Net. In some cases, U-Net 700 implements the reverse diffusion process described with reference to FIGS. 6, 9, and/or 14.

According to some aspects, U-Net 700 receives input features 705, where input features 705 include an initial resolution and an initial number of channels, and processes input features 705 using an initial neural network layer 710 (e.g., a convolutional network layer) to produce intermediate features 715. In some cases, intermediate features 715 are then down-sampled using a down-sampling layer 720 such that down-sampled features 725 have a resolution less than the initial resolution and a number of channels greater than the initial number of channels.

In some cases, this process is repeated multiple times, and then the process is reversed. For example, down-sampled features 725 are up-sampled using up-sampling process 730 to obtain up-sampled features 735. In some cases, up-sampled features 735 are combined with intermediate features 715 having a same resolution and number of channels via skip connection 740. In some cases, the combination of intermediate features 715 and up-sampled features 735 are processed using final neural network layer 745 to produce output features 750. In some cases, output features 750 have the same resolution as the initial resolution and the same number of channels as the initial number of channels.

According to some aspects, U-Net 700 receives additional input features to produce a conditionally generated output. In some cases, the additional input features include a vector representation of an input prompt (such as the prompt described with reference to FIG. 4). In some cases, the additional input features are combined with intermediate features 715 within U-Net 700 at one or more layers. For example, in some cases, a cross-attention module is used to combine the additional input features and intermediate features 715.

### Image Generation

A method for typographically aware image generation is described with reference to FIGS. 8-9. One or more aspects of the method include obtaining a prompt that includes a description of a typographic characteristic of text; encoding the prompt to obtain a prompt encoding; and generating an image that includes the text with the typographic characteristic based on the prompt encoding, wherein the image is generated using an image generation network that is trained to generate images having specific typographic characteristics. In some aspects, the image generation network includes a diffusion model conditioned on the prompt that includes the description of the typographic characteristic of the text.

Some examples of the method further include obtaining a noise image. Some examples further include removing noise from the noise image based on the prompt encoding to obtain the image. Some examples of the method further include receiving the prompt from a user via a graphical user interface. Some examples further include providing the image to the user via the graphical user interface in response to receiving the prompt.

In some aspects, the typographic characteristic comprises at least one of a font, a text size, a text justification, and a color. In some aspects, the prompt comprises a visual description of the image and a description of a location of the text within the image. In some aspects, the image generation network is trained using a training image and a training description of a text element of the training image.

FIG. 8 shows an example of a method 800 for generating an image including text according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 8, an image generation system (such as the image generation system described with reference to FIG. 1) generates an image that includes text with a typographic characteristic specified by a prompt using an image generation network (such as the image generation network described with reference to FIG. 5) that is trained to generate images having specific typographic characteristics. Accordingly, the image generation system is able to more quickly and efficiently generate an image depicting a text element than a user is capable of, while providing an image that more accurately depicts the text element than conventional image generation systems are capable of providing.

At operation 805, the system obtains a prompt that includes a description of a typographic characteristic of text. In some cases, the operations of this step refer to, or may be performed by, an image generation apparatus as described with reference to FIGS. 1, 5, and 11-13.

For example, in some cases, a user provides a prompt to the image generation apparatus. In some cases, the image generation apparatus receives the prompt from the user via a user interface (e.g., a graphical user interface) provided on a user device by the image generation apparatus. In some cases, the image generation apparatus retrieves the prompt from a database (such as the database described with reference to FIG. 5) or from another data source (such as the Internet). In some cases, the image generation apparatus retrieves the prompt in response to a user instruction.

In some cases, the prompt is a text prompt including text. In some cases, the prompt includes a visual description of the image and a description of a location of the text within the image.

In some cases, the typographic characteristic includes at least one of a font, a text size, a text justification, and a color. In some cases, the typographic characteristic includes a text style (e.g., a characteristic of the text that corresponds to an implementation of the text as a heading, a subheading, a body, a title, etc.) for the text.

At operation 810, the system encodes the prompt to obtain a prompt encoding. In some cases, the operations of this step refer to, or may be performed by, a multimodal encoder as described with reference to FIG. 5.

At operation 815, the system generates an image that includes the text with the typographic characteristic based on the prompt encoding, where the image is generated using an image generation network that is trained to generate images having specific typographic characteristics. In some cases, the operations of this step refer to, or may be performed by, an image generation network as described with reference to FIGS. 5 and 6.

In some cases, the image generation apparatus obtains a noise image and the image generation network removes noise from the noise image based on the prompt encoding to obtain the image. For example, in some cases, the image generation apparatus generates a noise image using a forward diffusion process (such as the forward diffusion process described with reference to FIGS. 6 and 9). In some cases, the image generation network obtains the image using a reverse diffusion process (such as the reverse diffusion process described with reference to FIGS. 6 and 9) guided by the prompt encoding.

In some cases, the image generation network is trained using a training image and a training description of a text element of the training image. In some cases, the image generation network is trained to generate images having specific typographic characteristics as described with reference to FIGS. 10-14.

In some cases, the image generation apparatus provides the image to the user (for example, via the graphical user interface provided on the user device) in response to receiving the prompt.

FIG. 9 shows an example of diffusion processes 900 according to aspects of the present disclosure. The example shown includes forward diffusion process 905 (such as the forward diffusion process described with reference to FIG. 6) and reverse diffusion process 910 (such as the reverse diffusion process described with reference to FIG. 6). In some cases, forward diffusion process 905 adds noise to an image (or image features in a latent space). In some cases, reverse diffusion process 910 denoises the image (or image features in the latent space) to obtain a denoised image.

According to some aspects, an image generation apparatus (such as the image generation apparatus described with reference to FIGS. 1, 5, and 11-13) uses forward diffusion process 905 to iteratively add Gaussian noise to an input at each diffusion step t according to a known variance schedule 0<β₁<β₂< . . . <β_{T}<1:

$$q ( {x}_{t} \vert {x}_{t - 1} ) = 𝒩 ( {x}_{t} ; \sqrt{1 - {β}_{t}} {x}_{t - 1} , {β}_{t} I ) \qquad ( 1 )$$

According to some aspects, the Gaussian noise is drawn from a Gaussian distribution with mean μₜ=\sqrt{1−βₜ}xₜ₋₁ and variance σ²=βₜ≥1 by sampling ϵ˜ [symbol] (0, I) and setting xₜ=\sqrt{1−βₜ}xₜ₋₁+\sqrt{βₜ}ϵ. Accordingly, beginning with an initial input x₀·forward diffusion process 905 produces x₁, . . . , xₜ, . . . x_{T}, where x_{T} is pure Gaussian noise.

In some cases, an observed variable x₀ (such as original image 930) is mapped in either a pixel space or a latent space to intermediate variables x₁, . . . , x_{T} using a Markov chain, where the intermediate variables x₁, . . . , x_{T} have a same dimensionality as the observed variable x₀. In some cases, the Markov chain gradually adds Gaussian noise to the observed variable x₀ or to the intermediate variables x₁, . . . , x_{T}, respectively, to obtain an approximate posterior q (x_{1:T}|x₀).

According to some aspects, during reverse diffusion process 910, an image generation network (such as the image generation network described with reference to FIG. 5) gradually removes noise from x₇ to obtain a prediction of the observed variable x₀ (e.g., a representation of what the image generation network thinks the original image 930 should be). In some cases, the prediction is influenced by a guidance prompt or a guidance vector (for example, a prompt or a prompt encoding described with reference to FIG. 8). A conditional distribution p(xₜ₋₁|xₜ) of the observed variable x₀ is unknown to the image generation network, however, as calculating the conditional distribution would require a knowledge of a distribution of all possible images. Accordingly, the image generation network is trained to approximate (e.g., learn) a conditional probability distribution p_{θ}(xₜ₋₁|xₜ) of the conditional distribution p(xₜ₋₁|xₜ):

$${p}_{θ} ( {x}_{t - 1} \vert {x}_{t} ) = 𝒩 ( {x}_{t - 1} ; {μ}_{θ} ( {x}_{t} , t ) , {\sum }_{θ} ( {x}_{t} , t ) ) \qquad ( 2 )$$

In some cases, a mean of the conditional probability distribution p_{θ}(xₜ₋₁|xₜ) is parameterized by μ_{θ} and a variance of the conditional probability distribution p_{θ}(xₜ₋₁|xₜ) is parameterized by Σ_{θ}. In some cases, the mean and the variance are conditioned on a noise level t (e.g., an amount of noise corresponding to a diffusion step t). According to some aspects, the image generation network is trained to learn the mean and/or the variance.

According to some aspects, the image generation network initiates reverse diffusion process 910 with noisy data x_{T} (such as noisy image 915). According to some aspects, the diffusion model iteratively denoises the noisy data x_{T} to obtain the conditional probability distribution p_{θ}(xₜ₋₁|xₜ). For example, in some cases, at each step t−1 of reverse diffusion process 910, the diffusion model takes xₜ (such as first intermediate image 920) and t as input, where t represents a step in a sequence of transitions associated with different noise levels, and iteratively outputs a prediction of xₜ₋₁ (such as second intermediate image 925) until the noisy data x_{T} is reverted to a prediction of the observed variable x₀(e.g., a predicted image for original image 930).

According to some aspects, a joint probability of a sequence of samples in the Markov chain is determined as a product of conditionals and a marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 3 )$$

In some cases, p(x_{T})= [symbol] (x_{T}; 0, I) is a pure noise distribution, as reverse diffusion process 910 takes an outcome of forward diffusion process 905 (e.g., a sample of pure noise x_{T}) as input, and Πₜ₌₁^{T}p_{θ}(xₜ₋₁|xₜ) represents a sequence of Gaussian transitions corresponding to a sequence of addition of Gaussian noise to a sample.

### Training

A method for typographically aware image generation is described with reference to FIGS. 10-14. One or more aspects of the method include obtaining training data comprising a training image and a training description of the training image, wherein the training description comprises a description of a typographic characteristic of the training image; computing a loss function for an image generation network based on the training data; and training the image generation network to generate images having the typographic characteristic based on the loss function.

Some examples of the method further include generating the training description of the training image using a multimodal text generation model based on the training image. Some examples of the method further include performing text recognition on the training image to obtain text data, wherein the multimodal text generation model takes the text data as an input.

Some examples of the method further include encoding the text data to obtain a font encoding using a font encoder, wherein the multimodal text generation model takes the font encoding as an input. Some examples of the method further include encoding the text data to obtain a text style encoding using a text style encoder, wherein the multimodal text generation model takes the text style encoding as an input.

Some examples of the method further include generating an intermediate description using the multimodal text generation model and generating the training description using a text combination model based on the intermediate description and the text data.

One or more aspects of the method include obtaining training data comprising a training image and a training description comprising a description of a typographic characteristic of the training image; performing text recognition on a predicted image to obtain text recognition data, wherein the predicted image is generated based on the description of a typographic characteristic; and training an image generation network to generate images having the typographic characteristic based on the text recognition data and the training description.

FIG. 10 shows an example of a method 1000 for training an image generation network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, an image generation system (such as the image generation system described with reference to FIG. 1) obtains training data, including a training image and a training description, for training an image generation network (such as the image generation network described with reference to FIG. 5) to generate an image having a specific typographic characteristic (for example, a typographic characteristic specified by a prompt).

Comparative training descriptions for comparative image generation machine learning models do not adequately describe typographic characteristics of comparative training images, and the comparative image generation models are therefore unable to learn to be typographically aware.

At operation 1005, the system obtains training data including a training image and a training description the training image, wherein the training description comprises a description of a typographic characteristic of the training image. In some cases, the operations of this step refer to, or may be performed by, a training component as described with reference to FIG. 5.

In some cases, a user provides the training image to the training component (for example, via a user interface provided on a user device by an image generation apparatus, such as the image generation apparatus described with reference to FIGS. 1, 5, and 11-13). In some cases, the training component retrieves the training image from a database (such as the database described with reference to FIG. 1) or from another data source (such as the Internet). In some cases, the training component retrieves the training image in response to a user instruction.

In some cases, the training component provides the training image to a multimodal text generation model of a machine learning model (such as the multimodal text generation model described with reference to FIG. 5). In some cases, the multimodal text generation model generates the training description as described with reference to FIGS. 11-13. In some cases, the machine learning model provides the training description to the training component.

At operation 1010, the system computes a loss function for an image generation network based on the training data. In some cases, the operations of this step refer to, or may be performed by, a training component as described with reference to FIG. 5. For example, in some cases, the training component computes the loss function as described with reference to FIG. 14.

At operation 1015, the system trains the image generation network to generate images having the typographic characteristic based on the loss function. In some cases, the operations of this step refer to, or may be performed by, a training component as described with reference to FIG. 5. For example, in some cases, the training component trains the image generation network as described with reference to FIG. 14.

FIG. 11 shows an example of a process for obtaining a decoded word 1150 for a training description according to aspects of the present disclosure. The example shown includes image generation apparatus 1100, training image 1125, visual object encoding 1130, text data 1135, text data encoding 1140, joint embedding space 1145, and decoded word 1150. Image generation apparatus 1100 is an example of, or includes aspects of, the corresponding element described with reference to FIGS. 1, 5, 12, and 13.

In one aspect, image generation apparatus 1100 includes object detection component 1105, text recognition component 1110, plurality of encoders 1115, and multimodal text generation model 1120. Object detection component 1105 is an example of, or includes aspects of, the corresponding element described with reference to FIG. 5. Text recognition component 1110 is an example of, or includes aspects of, the corresponding element described with reference to FIG. 5. Multimodal text generation model 1120 is an example of, or includes aspects of, the corresponding element described with reference to FIGS. 5 and 13.

Training image 1125 is an example of, or includes aspects of, the corresponding element described with reference to FIG. 12. Text data 1135 is an example of, or includes aspects of, the corresponding element described with reference to FIG. 12. Text data encoding 1140 is an example of, or includes aspects of, the corresponding element described with reference to FIG. 12.

Referring to FIG. 11, image generation apparatus 1100 uses multimodal text generation model 1120 to generate a sequence of words (including decoded word 1150) that describe training image 1125.

Object detection component 1105 performs object detection on training image 1125 to obtain visual object encoding 1130 in joint embedding space 1145. For example, in some cases, object detection component 1105 obtains a set of M visual objects depicted in training image 1125 and extracts, for an m^{th} object, where m=1, . . . , M, an appearance feature xₘ^{fr} and a four-dimensional location feature xₘ^{b} from the relative bounding box coordinates [xₘᵢₙ/Wᵢₘ, yₘᵢₙ/Hᵢₘ, xₘₐₓ/Wᵢₘ, yₘₐₓ/Hᵢₘ] of the m^{th} visual object, where Wᵢₘ and Hᵢₘ are respectively the width and height of training image 1125. In some cases, object detection component 1105 projects each of the appearance feature xₘ^{fr} and the location feature xₘ^{b} into joint embedding space 1145 using linear transformation and sums the projections to obtain visual object encoding 1130 (e.g., a visual object encoding xₘ^{obj}):

$${x}_{m}^{obj} = LN ( {W}_{1} {x}_{m}^{fr} ) + LN ( {W}_{2} {x}_{m}^{b} ) \qquad ( 4 )$$

Each of W₁ and W₂ are projection matrices, and LN (⋅) is layer normalization. Accordingly, a visual object encoding xₘ^{obj} (including visual object encoding 1130) is generated for each visual object in training image 1125 detected by object detection component 1105.

According to some aspects, text recognition component 1110 performs text recognition on training image 1125 to obtain text data 1135 for an n^{th} text object of N text objects included in training image 1125, where n=1, . . . , N. As used herein, a “text object” (or a “text element”) can refer to a word or a sequence of words. An example of a text object and information included in text data 1135 is described with reference to FIG. 12.

In some cases, image generation apparatus 1100 (and a machine learning model of image generation apparatus 1100, such as the machine learning model described with reference to FIG. 5) comprises plurality of encoders 1115. In some cases, plurality of encoders comprises a text encoder (such as the text encoder described with reference to FIG. 12), a location encoder (such as the location encoder described with reference to FIG. 12), a font encoder (such as the location encoder described with reference to FIGS. 5 and 12), and a text style encoder (such as the text style encoder described with reference to FIGS. 5 and 12).

In some cases, plurality of encoders 1115 output a plurality of encodings in joint embedding space 1145 for text data 1135 (such as the plurality of encodings described with reference to FIG. 12). In some cases, image generation apparatus 1100 combines the plurality of encodings to obtain text data encoding 1140 (e.g., a text data encoding xₙ^{txt}) in joint embedding space 1145 as described with reference to FIG. 12. Accordingly, in some cases, a text data encoding xₙ^{txt} (such as text data encoding 1140) is generated for each text object in training image 1125 recognized by text recognition component 1110.

In some cases, multimodal text generation model 1120 receives visual object encoding 1130 and text data encoding 1140 as input. In some cases, multimodal text generation model 1120 applies a self-attention mechanism of a stack of L transformer layers with a hidden dimension of d (where d is a number of dimensions of joint embedding space 1145) over each visual object encoding from {xₘ^{obj}} and each text data encoding from {xₙ^{txt}}, such that each visual object encoding xₘ^{obj} attends to both the other visual object encodings xₘ^{obj} and each text data encoding xₙ^{txt}, and each text data encoding xₙ^{txt} attends to the other text data encodings xₙ^{txt} and each visual object encoding xₘ^{obj}, to obtain d-dimensional feature vectors {z₁^{txt}, . . . , z_{N}^{txt}} (e.g., enriched multimodal embeddings) for each text data encoding xₙ^{txt}.

In some cases, multimodal text generation model 1120 iteratively decodes each d-dimensional feature vector in T autoregressive steps to determine a next decoded word in a sequence of T decoded words (including decoded word 1150), where each decoded word is either a text object or a portion of a text object recognized in training image 1125 or a word drawn from a vocabulary of V words known to multimodal text generation model 1120.

For example, at each t^{th} decoding step, multimodal text generation model 1120 predicts a V-dimensional vocabulary score y_{t,i}^{voc} for selecting an i^{th} word from the vocabulary, where i=1, . . . , V, as the decoded word and an N-dimensional text object score y_{t,n}^{txt} for selecting a word from a text object in training image 1125 as the decoded word:

$${y}_{t , i}^{voc} = {( {w}_{i}^{voc} )}^{T} {z}_{t}^{dec} + {b}_{i}^{voc} \qquad ( 5 )$$

$${y}_{t , n}^{txt} = {( {W}^{txt} {z}_{n}^{txt} + {b}^{txt} )}^{T} ( {W}^{dec} {z}_{t}^{dec} + {b}^{dec} ) \qquad ( 6 )$$

wᵢ^{voc} is a d-dimensional parameter for the i^{th} word from the vocabulary, bᵢ^{voc} is a scalar parameter, W^{txt} and W^{dec} are d×d scalar matrices, and b^{txt} and b^{dec} are d-dimensional vectors. In some cases, the vocabulary score y_{t,i}^{voc} is predicted as a linear layer. In some cases, the text object score y_{t,n}^{txt} is predicted using a pointer network of multimodal text generation model 1120 via bilinear interaction between the d-dimensional representation zₜ^{dec} of the previous decoded word and the d-dimensional feature vector zₙ^{txt} for the text data encoding xₙ^{txt}. In some cases, multimodal text generation model 1120 predicts the vocabulary score y_{t,i}^{voc} and the text object score y_{t,n}^{txt} using a positional embedding vector corresponding to step t and a type embedding vector corresponding to whether a vocabulary word or a word from training image 1125 was selected as the decoded word in the previous decoding step t−1 as additional inputs.

zₜ^{dec} is a d-dimensional representation of the decoded word selected at the previous decoding step (where the decoding steps are initialized using a <begin> token and ended with an <end> token), where zₜ^{dec} is a representation of either a text data encoding xₙ^{txt} or a weight vector wᵢ^{voc} of a vocabulary word.

In some cases, multimodal text generation model 1120 takes an argmax on a concatenation yₜ^{all}=[yₜ^{voc}; yₜ^{txt}] to determine a top score, where either a vocabulary word or a word recognized in training image 1125 corresponding to the top score is selected as the decoded word. In some cases, multimodal text generation model 1120 concatenates each successive decoded word to form a sequence of decoded wors, and repeats the autoregressive selection sequence until the <end> token is reached. In some cases, the training description (or the intermediate description) described with reference to FIG. 13 comprises the sequence of decoded words.

According to some aspects, multimodal text generation model 1120 is implemented according to a principle employed by a Multimodal Multi-Copy Mesh (M4C) model for a Visual Question Answering (VQA) task. The M4C model uses transformer layers to generate an answer to a question about an image, where the answer comprises a predicted sequence of decoded words and the answer is predicted based on feature representations of the question, objects detected in the image, and optical character recognition (OCR) tokens for text recognized in the image, where the feature representations of the OCR tokens include a word embedding, an appearance feature from an object detector, a pyramidal histogram of characters vector to identify characters present in the OCR token, and a location of the OCR token's bounding box coordinates within the image.

However, unlike the M4C model, multimodal text generation model 1120 omits an input relating to a question and provides text data including a font encoding and a text style encoding as input (as further described with reference to FIG. 12) to generate a description for an image that includes a specification of a typographic characteristic of the image, rather than an answer for a question about the image that does not describe a typographic characteristic of the image.

According to some aspects, a training component (such as the training component described with reference to FIG. 5) trains multimodal text generation model 1120 by updating multimodal text generation parameters of multimodal text generation model 1120 according to a multimodal text generation loss.

The term “loss function” refers to a function that impacts how a machine learning model is trained in a supervised learning model. For example, during each training iteration, the output of the machine learning model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In some cases, the multimodal text generation loss is determined based on a comparison of an output of multimodal text generation model 1120 for an image and a ground-truth caption for the image, where the ground-truth caption comprises text relating to text included in the image.

However, the ground-truth caption for training multimodal text generation model 1120 does not describe a font or a font style for the text included in the image, and so the ground-truth caption for the image for training multimodal text generation model 1120 to generate the training description (or the intermediate description) is not suitable as training data for training an image generation network (such as the image generation network described with reference to FIG. 5) to generate a specific typographic characteristic.

FIG. 12 shows an example of a process for obtaining a text recognition token encoding 1255 according to aspects of the present disclosure. The example shown includes image generation apparatus 1200, training image 1225, text object 1230, text data 1235, text encoding 1240, location encoding 1245, font encoding 1250, text style encoding 1255, and text data encoding 1260.

Image generation apparatus 1200 is an example of, or includes aspects of, the corresponding element described with reference to FIGS. 1, 5, 11, and 13. In one aspect, image generation apparatus 1200 includes text encoder 1205, location encoder 1210, font encoder 1215, and text style encoder 1220.

Font encoder 1215 is an example of, or includes aspects of, the corresponding element described with reference to FIG. 5. Text style encoder 1220 is an example of, or includes aspects of, the corresponding element described with reference to FIG. 5. According to some aspects, one or more of text encoder 1205, location encoder 1210, font encoder 1215, and text style encoder 1220 are comprised in the plurality of encoders described with reference to FIG. 11.

Training image 1225 is an example of, or includes aspects of, the corresponding element described with reference to FIG. 11. Text data 1235 is an example of, or includes aspects of, the corresponding element described with reference to FIG. 11.

Text encoding 1240, location encoding 1245, font encoding 1250, and text style encoding 1205 are examples of, or include aspects of, the corresponding elements described with reference to FIG. 13. Text data encoding 1260 is an example of, or includes aspects of, the corresponding element described with reference to FIG. 11.

Referring to FIG. 12, image generation apparatus 1200 obtains text data 1235 for text object 1230 (e.g., a text element) of training image 1225 using a text recognition component (such as the text recognition component described with reference to FIGS. 5 and 11).

As shown in FIG. 12, text object 1230 includes the words “support network” in capital letters. As shown in FIG. 12, text data 1235 includes an identifier, bounds information, frame information, background color information, text color information, font information, layout (e.g., justification) information, text information (including each word comprised in text object 1230 and a case (e.g., capitalization) and relative spacing for each character of text object 1230), and font size information.

Based on text data 1235, text encoder 1205, location encoder 1210, font encoder 1215, and text style encoder 1220 respectively determine text encoding 1240, location encoding 1245, font encoding 1250, and text style encoding 1255.

According to some aspects, text encoder 1205 comprises text encoding parameters stored in a memory unit (such as the memory unit described with reference to FIG. 5). According to some aspects, text encoder 1205 is implemented as software stored in the memory unit and executable by a processor unit (such as the processor unit described with reference to FIG. 5), as firmware, as one or more hardware circuits, or as a combination thereof.

In some cases, text encoder 1205 comprises one or more ANNs (such as an RNN, a transformer, etc.) that are trained, designed, and/or configured to encode text data 1235 to obtain text encoding 1240. For example, in some cases, text encoder 1205 comprises a word2vec model. A Word2Vec model may comprise a two-layer ANN trained to reconstruct the context of terms in a document. A Word2vec model takes a corpus of documents as input and produces a vector space as output. The resulting vector space may comprise hundreds of dimensions, with each term in the corpus assigned a corresponding vector in the space. The distance between the vectors may be compared by taking the cosine between two vectors. Word vectors that share a common context in the corpus will be located close to each other in the vector space.

In some cases, text encoder 1205 projects text encoding 1240 into a joint embedding space (such as the joint embedding space described with reference to FIG. 11) using linear projection.

According to some aspects, location encoder 1210 comprises location encoding parameters stored in a memory unit (such as the memory unit described with reference to FIG. 5). According to some aspects, location encoder 1210 is implemented as software stored in the memory unit and executable by a processor unit (such as the processor unit described with reference to FIG. 5), as firmware, as one or more hardware circuits, or as a combination thereof.

In some cases, location encoder 1210 comprises one or more ANNs (such as a CNN, etc.) that are trained, designed, and/or configured to encode text data 1235 to obtain location encoding 1245. For example, in some cases, location encoding 1245 is an encoding of location data (such as bounds information, frame information, or bounding box coordinates for a bounding box for text object 1230 relative to training image 1225). In some cases, location encoder 1210 projects location encoding 1245 into the joint embedding space using linear projection.

According to some aspects, font encoder 1215 encodes text data 1235 to obtain font encoding 1250. In some cases, font encoding 1250 comprises a multi-dimensional (e.g., 784-dimensional) representation of font information included in text data 1235. In some cases, font encoding 1250 also comprises one or more font metrics.

As used herein, a “glyph” can refer to a representation of a character. Examples of a font metric include a glyph width (e.g., an absolute difference for a minimum glyph position and a maximum glyph position in an x direction), a glyph height (e.g., an absolute difference for a minimum glyph position and a maximum glyph position in a y direction crossing the x direction), a glyph ascender (e.g., an absolute difference for a minimum glyph position in the y direction and a maximum glyph position in the x direction), a glyph descender (e.g., an absolute difference for a minimum glyph position in the y direction and a baseline), a height for a small case glyph, a height for a capital case glyph, units per Em computed from a glyph using a standard algorithm, a stem width, an average glyph contrast, and a stem angle.

In some cases, font encoder 1215 projects font encoding 1250 into the joint embedding space using linear projection.

According to some aspects, text style encoder 1220 encodes text data 1235 to obtain text style encoding 1255. In some cases, image generation apparatus 1200 applies a heuristic to text data 1235 to obtain text style information that text style encoder 1220 encodes to obtain text style encoding 1255.

For example, in some cases, image generation apparatus 1200 calculates an average font size for text object 1230 by dividing a font size (for example, given in units of pixel height) by an ascender plus a descender for text object 1230. In some cases, image generation apparatus 1200 measures a distance of a bounding box for text object 1230 from one or more of a bounding box for another text object included in training image 1225 or a bounding box for a visual object included in training image 1225 and detected by an object detection component (such as the object detection component described with reference to FIGS. 5 and 11). In some cases, image generation apparatus 1200 compares a capital height, a font size, and a bounding box of text object 1230 to one or more predefined text style values. In some cases, image generation apparatus 1200 determines the text style information including a text style classification for text object 1230 (e.g., classification as a heading, a subheading, a body, a title, etc.) based on a corresponding range of values for the average font size, the bounding box distance, or the value determined by the comparison.

In some cases, text style encoder 1220 encodes the text style information to obtain text style encoding 1255. In some cases, text style encoding 1255 is a one hot vector. In some cases, text style encoder 1220 projects text style encoding 1255 to the joint embedding space using linear projection.

In some cases, image generation apparatus 1200 combines the joint embedding space projections (for example, by summation) of each of text encoding 1240, location encoding 1245, font encoding 1250, and text style encoding 1255 to obtain text data encoding 1260. In some cases, the combination includes layer normalization.

FIG. 13 shows an example of a process for obtaining a training description 1350 according to aspects of the present disclosure. The example shown includes image generation apparatus 1300, first decoded word 1315, last decoded word 1320, intermediate description 1325, text encoding(s) 1330, location encoding(s) 1335, font encoding(s) 1340, text style encoding(s) 1345, and training description 1350.

Image generation apparatus 1300 is an example of, or includes aspects of, the corresponding element described with reference to FIGS. 1, 5, 11, and 12. In one aspect, image generation apparatus 1300 includes multimodal text generation model 1305 and text combination model 1310. Multimodal text generation model 1305 is an example of, or includes aspects of, the corresponding element described with reference to FIGS. 5 and 11. Text combination model 1310 is an example of, or includes aspects of, the corresponding element described with reference to FIG. 5.

Text encoding(s) 1330, location encoding(s) 1335, font encoding(s) 1340, and text style encoding(s) 1345 are examples of, or include aspects of, the corresponding elements described with reference to FIG. 12.

Referring to FIG. 13, multimodal text generation model 1305 determines first decoded word 1315 to last decoded word 1320 to determine a sequence of words for a training image as described with reference to FIG. 11 (for example, by concatenating first decoded word 1315 through last decoded word 1320). In some cases, the sequence of words is the training description.

In some cases, the sequence of words omits font information and/or text style information for the training image and the sequence of words is an intermediate description (such as intermediate description 1325). For example, as shown in FIG. 13, intermediate description 1325 comprises “a man and a dog working on a desk, text reading LOCAL BUSINESS on the top right above SUPPORT NETWORK”, but omits font information and text style information for each text object LOCAL BUSINESS and SUPPORT NETWORK included in the training image.

In some cases, text combination model 1310 receives intermediate description 1325 and one or more of text encoding(s) 1330, location encoding(s) 1335, font encoding(s) 1340, and text style encoding(s) 1345 for the training image as input and generates training description 1350 in response, where training description 1350 includes font and/or text style information for one or more text objects included in the training image. For example, as shown in FIG. 13, training description 1350 comprises “a man and a dog working on a desk, LOCAL BUSINESSES rendered with a formal font as a title on the top right combined with subheading SUPPORT NETWORK in clean font”, where “formal font” and “clean font” respectively comprise font information for text objects LOCAL BUSINESSES and SUPPORT NETWORK, and “title” and “subheading” respectively comprise text style information for the text objects. In some cases, “font information” refers to a characteristic associated with a font included in the training image. In some cases, text combination model 1310 determines the font information based on an encoding of a font tag included in font encoding(s) 1340.

In some cases, text combination model 1310 is trained to combine intermediate description 1325 with font information provided by font encoding(s) 1340 and text style encoding(s) 1345 to generate one or more preliminary training descriptions, where training description 1350 is generated based on the one or more preliminary training descriptions. Examples of preliminary training descriptions that can be generated based on templates include “<a text object included in intermediate description 1325> is rendered with font <font provided in font encoding(s) 1340 for the text object>”, “<a text object included in intermediate description 1325> is rendered with a <font style information (such as clean, comic, formal, etc.) associated with font provided in font encoding(s) 1340 for the text object> font”, “<a text object included in intermediate description 1325> is used as <text style provided in text style encoding for the text object>”, and the like, which serve as predetermined few-shot learning inputs for text combination model 1310.

FIG. 14 shows an example of a method 1400 for training an image generation network according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 14, an image generation system (such as the image generation system described with reference to FIG. 1) trains an image generation network (such as the image generation network described with reference to FIG. 5) to generate an image, where the image generation process is conditioned on a prompt that includes a description of a typographic characteristic of text. Accordingly, in some cases, the image generation network is trained to generate an image having a specific typographic characteristic (such as a typographic characteristic included in a training description, such as the training description described with reference to FIGS. 10-13).

At operation 1405, the system initializes the image generation network. In some cases, the operations of this step refer to, or may be performed by, a training component as described with reference to FIG. 5. In some cases, the initialization includes defining the architecture of the image generation network and establishing initial values for image generation parameters of the image generation network. In some cases, the training component initializes the image generation network to implement a U-Net architecture (such as the U-Net architecture described with reference to FIG. 7). In some cases, the initialization includes defining hyperparameters of the architecture of the image generation network, such as a number of layers, a resolution and channels of each layer block, a location of skip connections, and the like.

At operation 1410, the system adds noise to a training image (such as the training image described with reference to FIGS. 11-12) using a forward diffusion process (such as the forward diffusion process described with reference to FIGS. 6 and 10) in N stages. In some cases, the operations of this step refer to, or may be performed by, a training component as described with reference to FIG. 5. In some cases, the training component retrieves the training image from a database (such as the database described with reference to FIG. 1).

At operation 1415, at each stage n, starting with stage N, the system predicts an image for stage n−1 using a reverse diffusion process conditioned on the training description for the training image. In some cases, the operations of this step refer to, or may be performed by, the image generation network. According to some aspects, the image generation network performs the reverse diffusion process as described with reference to FIGS. 6 and 10, where each stage n corresponds to a diffusion step t, to predict noise that was added by the forward diffusion process.

For example, in some cases, a multimodal encoder (such as the multimodal encoder described with reference to FIGS. 5 and 6) retrieves the training description (for example, from the database) and generates guidance features in a guidance space for the training description. At each stage, the image generation network predicts noise that can be removed from an intermediate image to obtain a predicted image that aligns with the guidance features. In some cases, an intermediate image is predicted at each stage of the training process.

At operation 1420, the system compares the predicted image at stage n−1 to an actual image (or image features), such as the image at stage n−1 or the original input image (e.g., the training image). In some cases, the operations of this step refer to, or may be performed by, a training component as described with reference to FIG. 5. In some cases, the training component computes a loss function based on the comparison.

At operation 1425, the system updates parameters of the image generation network based on the comparison. In some cases, the operations of this step refer to, or may be performed by, a training component as described with reference to FIG. 5. In some cases, the training component updates the image generation parameters of the image generation network based on the loss function. For example, in some cases, the training component updates parameters of the U-Net using gradient descent. In some cases, the training component trains the U-Net to learn time-dependent parameters of the Gaussian transitions.

In some cases, the image generation apparatus performs text recognition on the predicted image (for example, using a text recognition component such as the text recognition component described with reference to FIG. 5) to obtain text recognition data. In some cases, the training component computes the loss function based on a comparison of the training description and the text recognition data.

FIG. 15 shows an example of a computing device 1500 for multi-modal image editing according to aspects of the present disclosure. In one aspect, computing device 1500 includes processor(s) 1505, memory subsystem 1510, communication interface 1515, I/O interface 1520, user interface component(s) 1525, and channel 1530.

In some embodiments, computing device 1500 is an example of, or includes aspects of, the image generation apparatus described with reference to FIGS. 1, 5, and 11-13. In some embodiments, computing device 1500 includes one or more processors 1505 that can execute instructions stored in memory subsystem 1510 to obtain a prompt that includes a description of a typographic characteristic of text; encode the prompt to obtain a prompt encoding; and generate an image that includes the text with the typographic characteristic based on the prompt encoding, wherein the image is generated using an image generation network that is trained to generate images having specific typographic characteristics.

According to some aspects, computing device 1500 includes one or more processors 1505. Processor(s) 1505 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1510 includes one or more memory devices. Memory subsystem 1510 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote control device interfaced with a user interface directly or through the I/O controller), or a combination thereof. In some cases, user interface component(s) 1525 include a GUI.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image generation, comprising:
obtaining a prompt that includes a description of a typographic characteristic of text;
encoding the prompt to obtain a prompt encoding; and
generating an image that includes the text with the typographic characteristic based on the prompt encoding, wherein the image is generated using an image generation network that is trained to generate images having specific typographic characteristics.

2. The method of claim 1, wherein generating the image further comprises:
obtaining a noise image; and
removing noise from the noise image based on the prompt encoding to obtain the image.

3. The method of claim 1, wherein:
the typographic characteristic comprises at least one of a font, a text size, a text justification, and a color.

4. The method of claim 1, wherein:
the prompt comprises a visual description of the image and a description of a location of the text within the image.

5. The method of claim 1, wherein:
the image generation network is trained using a training image and a training description of a text element of the training image.

6. The method of claim 1, wherein:
the image generation network comprises a diffusion model conditioned on the prompt that includes the description of the typographic characteristic of the text.

7. A method for image generation, comprising:
obtaining training data comprising a training image and a training description comprising a description of a typographic characteristic of the training image;
performing text recognition on a predicted image to obtain text recognition data, wherein the predicted image is generated based on the description of a typographic characteristic; and
training an image generation network to generate images having the typographic characteristic based on the text recognition data and the training description.

8. The method of claim 7, wherein the training description is generated using a multimodal text generation model based on the training image.

9. The method of claim 8, wherein the training description is generated by generating an intermediate description using the multimodal text generation model and generating the training description using a text combination model based on the intermediate description.

10. The method of claim 8, further comprising:
encoding text data to obtain a font encoding using a font encoder, wherein the multimodal text generation model takes the font encoding as an input.

11. The method of claim 8, further comprising:
encoding text data to obtain a text style encoding using a text style encoder, wherein the multimodal text generation model takes the text style encoding as an input.

12. The method of claim 7, further comprising:
computing a loss function for the image generation network based on the text recognition data and the training description, wherein the training is based on the loss function.

13. A system for image generation, comprising:
one or more processors;
one or more memory components coupled with the one or more processors; and
an image generation network comprising parameters stored in the one or more memory components and trained to generate images having specific typographic characteristics, wherein the image generation network is trained using a training image and a training description of a text element of the training image.

14. The system of claim 13, further comprising:
a multimodal text generation model trained to generate the training description of the training image based on the training image.

15. The system of claim 13, further comprising:
a text recognition component configured to perform text recognition on the training image to obtain text data, wherein the training description is generated based on the text data.

16. The system of claim 15, further comprising:
a font encoder configured to encode the text data to obtain a font encoding, wherein the training description is generated based on the font encoding.

17. The system of claim 15, further comprising:
a text style encoder configured to encode the text data to obtain a text style encoding, wherein the training description is generated based on the text style encoding.

18. The system of claim 13, further comprising:
an object detection component configured to detect an object included in the training image and to generate an object encoding based on the object, wherein the training description is generated based on the object encoding.

19. The system of claim 13, further comprising:
a text combination model configured to generate the training description based on a description of the training image and a description of the text element.

20. The system of claim 13, wherein:
the image generation network is a text-guided diffusion model.
